(19) United States
(12) Patent Application Publication
(10) Pub. No.: US 2010/0198863 A1
(43) Pub. Date: Aug. 5, 2010

(54) CAREER AUTHENTICATION SYSTEM, CAREER AUTHENTICATION METHOD USING THE SAME, AND RECORDING MEDIUM HAVING PROGRAM STORED THEREIN TO EXECUTE CAREER AUTHENTICATION METHOD

(75) Inventors: Jongwon Lee, Seoul (JP); Byoungeun Park, Cheonan-si (KR)

Correspondence Address: ALLEMAN HALL MCCOY RUSSELL & TUTTLE LLP, 806 SW BROADWAY, SUITE 600, PORTLAND, OR, 97205-3335, US

(73) Assignee: Hasung T Land Co., Ltd, Seoul (KR)

(21) Appl. No.: 12/666,560

(22) PCT Filed: Jun. 23, 2008
(86) PCT No.: PCT/KR2008/003564

§ 371 Date: Dec. 23, 2009

(30) Foreign Application Priority Data
Jun. 28, 2007 (KR) 10-2007-0064463

(51) Int. Cl. G06F 17/30

(52) U.S. Cl. 707/769; 707/E17.014

(57) ABSTRACT

The present invention relates to a career authentication system, a career authentication method using the same, and a recording medium. The career authentication system includes at least one corporation server that performs career verification for an experienced man according to a career verification request from the experienced man and outputs a result; and a public authentication center server that receives career verification data of the career verified experienced man from the at least one corporation server through a communication network in real time and stores the career verification data, performs career examination on the basis of the career verification data of the experienced man and digitizes and stores an approved career, and outputs the stored approved career information of the experienced man at the time of a career information request for the experienced man from the outside.

### TECHNICAL FIELD

The present invention relates to a career authentication system, a career authentication method using the same, and a readable/writable recording medium that has a program recorded therein to execute the career authentication method. More particularly, the present invention relates to a user career authentication system in which, when a member who joins a public authentication center requests to perform a career authentication process, a standby file is generated to authenticate a career using a smart card or on online, a public authentication center server includes a program that allows career particulars of various users to be recognized on the Internet, and a system that simply examines a career using a program that allows a documentary evidence proving an objective career truth and a certificate to be issued and career particulars for individual users are managed as one system, a career authentication method using the same, and a readable/writable recording medium that has a program stored therein to execute the career authentication method.

The present invention relates to a career authentication system in which, when employees desire consultation in order to manage their careers, a public authentication center server as a career management subject asks a specialist's advice and educates the employees or understands weak points thereof, and provides a customized service, such as positive activity in managing careers and guidance for contents of a civil appeal administration work of a special law for a related job, to each person to become a social guider of employees, a career authentication method using the same, and a recording medium thereof.

### BACKGROUND ART

In recent years, a variety of systems for personal careers of job seekers have been developed. However, there is no system that manages careers of employees in individual fields using one system, which also includes individual careers of the employees and special laws of the industrial fields. It is increasingly required to authenticate careers of engineers as a part of employees in various industries by various special laws, and thus the engineers join various associations/groups such that careers thereof are managed. However, in order to authenticate careers by the associations/groups, economic/temporary losses are large. Further, if they join a large number of associations/groups, respectively, an economic burden actually increases. In particular, administrative litigation is increasing due to a problem in recording careers of engineers on the basis of a special law relating to a specific technology field. This problem may occur due to unprofessional career management in each association/group and dynamic relationships between interest parties. Therefore, objective and proper career management at a professional and litmusless position are required.

Various services are provided or a large amount of information is quickly obtained through cyber space, such as the Internet or communication. The Internet is considered a fast optical communication, which is an aggregate of computer networks using various protocols, such as a TCP/IP protocol, and is generally operated by a client/server structure using an HTML (Hypertext) language. A client and a server use a function provided through an HTTP (hyper text transfer protocol) to communicate with each other, and the client can have access to a server using a URL.

Under the existing special laws, engineers make a certificate of a legal form on paper signed through offline or the mail, claims the association/group or a corporation for examination with various verification forms, and then waits for a long period of time, which consumes a large amount of time or costs. Because a number of related special laws are regulated, the engineers join groups related to the special laws, which increases a membership fee and lowers the efficiency of human resources for career authentication.

As described above, when career authentication of engineers who belong to a special law in a specific field in the related art is performed offline, career authentication is not economical and a career authentication procedure becomes complex. Therefore, it is required to develop a system that can operate while linking the existing career authentication system used by each association/group.

Meanwhile, known are various elements that are needed to construct an economical and rational career authentication system online and provide necessary data under various special laws to related associations/groups. For example, an operating system based on a CPU, a network manager, and a cipher processor can be easily recognized by those skilled in the art.

FIG. 1 is a conceptual diagram schematically illustrating a process of performing career authentication according to the related art and FIG. 2 is a flowchart illustrating a career statement and an examination procedure shown in FIG. 1.

Referring to FIGS. 1 and 2, a career of a user is authenticated from a corporation where the user accumulates a career by a seal on a paper form. That is, an employee (or user) W-10 receives legal verification forms (required documents) from a career authentication agency A-20 and goes to a corporation F-30 where the user accumulates a career or uses the mail to submit the legal verification forms to a personnel director. In this case, the personnel director refers to written evidential material needed to authenticate a career, draws up a career certificate, gets the signature from a power holder, and issues the career certificate. The employee W-10 that has been provided with the career certificate visits related public corporations issuing four social insurance entrance certificates or a withhold payment certificate to objectively verify that the employee is in office, directly gets legal verification forms, and submits the written form to a career authentication agency that requires career authentication. This procedure is related to personal information and all work related to the procedure are processed offline, and needs a process of confirming an employee's identity. As such, an identity confirmation procedure is performed offline, which causes the employee who desires to be subjected to career authentication to consume a large amount of time and costs. Further, when the employee visits a career authentication agency and submits a career certificate to the career authentication agency, the employee must stand in line for a long time, and thus it is inconvenient for the employee.

If the employee submits to a career authentication agency career application documents that the employee needs under each special law, a receptionist determines only whether elementary required documents are abnormal and accepts the career application. After the employee pays the application fee and the receptionist confirms the received money, the receptionist inputs and stores necessary information using a computer. After the necessary information is input and stored using the computer, an examiner determines whether the career is true under the related special law on the basis of whether the documents are abnormal and objectiveness and validity. When it is determined that the career is true, the career authentication process ends.

An example where career authentication is needed under a special law will now be described in detail with reference to FIG. 2. A career examination claim process needed in order that an engineer obtains a career certificate from a Korean 0000 association and a certificate of qualification under a special law includes a required document preparation step (S2), a career statement acceptance (mail/visit) step (S4), an employee's document acceptance (submit acceptance) step (S6), an acceptance document passage or non-passage determination step (S8), an acceptance document input step using a computer (S10), a career content input step using a computer (S12), a career examination passage or non-passage determination step (S14), a career determination step (S16), and a notebook issue step (S18). In the case of the career examination non-passage, a partial career document recognition step, an entire career non-recognition (repayment decision) step, a personal notification step at the time of being short of documents, a document details confirmation step, and a career content record confirmation step are added.

The engineer follows a predetermined legal form, and prepares documents that can verify the past career truth on the basis of objectivity in regard to all documents and certificates, rearranges the documents and certificates according to the legal form, and refers to the association for examination. The required career contents are slightly different according to the aim of each special law. There is a problem in that, in order to verify the past old career truth or the objective truth, the engineer visits many corporations to verify objective truths, gets the approval on career verification material offline, and receives evidential material supporting the verification truth, which makes it difficult to verify the career. Actually, as the career particulars under this special law become increasingly associated with construction ordering or economic gain, various civil applications for Fair Trade Commission or the like are increasing.

Since related associations under various special laws manage careers and civil application works, it becomes subjected to a civil appliance of a fair trade, and exposed to adverse criticism of objective fairness.

Due to the above processes, it takes a minimum of two or three days to a maximum of one week until the career of the employee is confirmed. Actually, career authentication is related to a plurality of similar special laws, not just one special law, which may hinder what the employee does for a living. At the present time, since an average life span cycle of all corporations is shorter than 6 years, the career authentication agency is not reliable, and thus all employees need a career authentication system.

### DISCLOSURE OF INVENTION

### Technical Problem

The present invention has been suggested in consideration of the problem in the related art in that an average life span cycle of corporations is shorter than six years, and as a result, it is increasingly required to authenticate careers of employees in various industrial fields, but the career authentication is not effective. An object of the present invention is to provide a career authentication system in which time and costs needed to authenticate careers are reduced, engineers in various industrial fields are managed by a career authentication system that performs an objective and proper procedure using one public authentication center server so as to develop an industry, and career data of excellent engineers and employees who are engaged in various fields and participated in various development projects is effectively managed to promote public interests, a career authentication method using the same, and a readable/writable recording medium that has a program recorded therein to execute the career authentication method.

Another object of the present invention is to provide a career authentication system in which participated businesses and career particulars of employees who are engaged in various fields are specifically recorded, technical particulars needed to manage personal careers with the technical development in a society can be provided through consultation with an expert to adjust to a social change, such that employees develop their abilities to provide excellent labor for businesses and accumulate careers, which leads to public interests, a career authentication method using the same, and a readable/writable recording medium that has a program recorded therein to execute the career authentication method.

### Technical Solution

In order to achieve the above-described objects, according to an embodiment of the present invention, a career authentication system includes at least one corporation server that performs career verification for an experienced man according to a career verification request from the experienced man and outputs a result; and a public authentication center server that receives career verification data of the career verified experienced man from the at least one corporation server through a communication network in real time and stores the career verification data, performs career examination on the basis of the career verification data of the experienced man and digitizes and stores an approved career, and outputs the stored approved career information of the experienced man at the time of a career information request for the experienced man from the outside.

According to another aspect of the present invention, there is provided a career authentication method using a career authentication system that includes a public authentication center server connected to a corporation server through a communication network. The career authentication method includes a first step of receiving a career authentication request from a member; a second step of allowing the corporation server to download a career verification program from the public authentication center server and perform a career verification process, and allowing a representative of a corporation to approve career verification data by the career verification process; a third step of classifying the career verification data approved by the corporation server according to an acceptance signal from the member and storing the classified data in a database; and a fourth step of determining a public career recognition range, assigning an approval code of a personal career for the member, changing the data to approved data, and storing the approved data in the database.

### Advantageous Effects

As described above, according to the career authentication system, the career authentication method using the same, and a readable/writable recording medium that has a program stored therein to execute the career authentication method, various verification forms that are not produced online in the related art can be prevented from forging using effective Internet media while economic burden and time can be effectively reduced.

According to the present invention, a user is provided with an objective and proper career management to effectively manage his or her career, which helps the user to improve productivity and increase wages so as to increase an income. It is possible to drastically reduce time and costs that are needed to perform a career statement procedure under each special law. A banking agency can secure potential customers, earn automatic transfer gains and deposit earnings, and obtain a promotional effect through work cooperation, which revitalizes a financial industry. A nation can manage people engaged in all industrial fields by using one collective system. As a result, it is possible to effectively manage excellent engineers or people in all industrial fields that contribute to technical development and national economic development, which leads to public interests.

Further, according to the present invention, the pool of competitive employees can be increased during a labor shortage due to an increase in unemployment, and national productivity can be improved. Most of all, as an industry is rapidly developed after liberation, careers for industries that are human powered are effectively managed, a unique social system is developed, and international data for industries that are man powered can be constructed. In other words, according to the present invention, time and cost for authenticating procedure can be reduced, and reliability for confirming past career truth can be increased. Further, since system of this invention is convergence system including every industrial human resource and every special laws, the system can be managed more efficiently.

Furthermore, the operator of the public authentication center server can profit by work cooperation of the related associations/groups using the corresponding data through specialized and rationalized management of the people engaged in the industry and the public authentication center server can be maintained by possibly charging a consultation fee while providing the high-level specialized consultation.

### BRIEF DESCRIPTION OF THE DRAWINGS

FIG. 1 is a conceptual diagram schematically illustrating a process of performing career authentication according to the related art.

FIG. 2 is a flowchart illustrating a career statement and examination procedure shown in FIG. 1.

FIG. 3 is a diagram illustrating a schematic structure of a career authentication system according to the present invention.

FIG. 4 is a block diagram schematically illustrating an inner structure of a public authentication center server shown in FIG. 3.

FIG. 5 is a flowchart schematically illustrating a user career authentication process according to the present invention.

FIG. 6 is a flowchart illustrating a user career examination and an approval procedure according to the present invention.

FIG. 7 is a flowchart illustrating a user career approval data transmission process according to the present invention.

FIG. 8 is a flowchart illustrating a user career verification process according to the present invention.

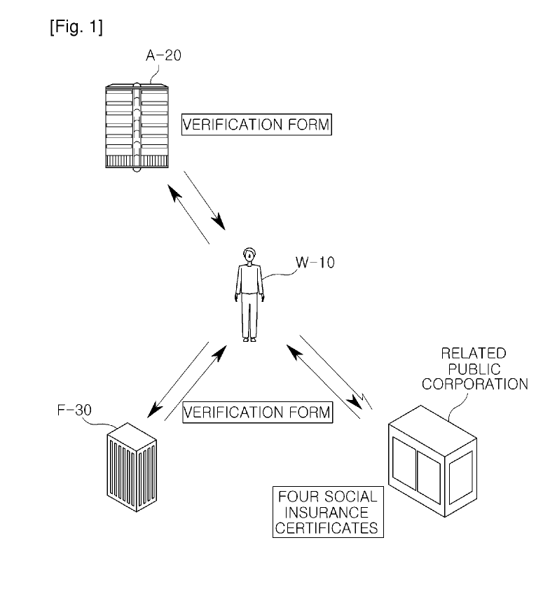

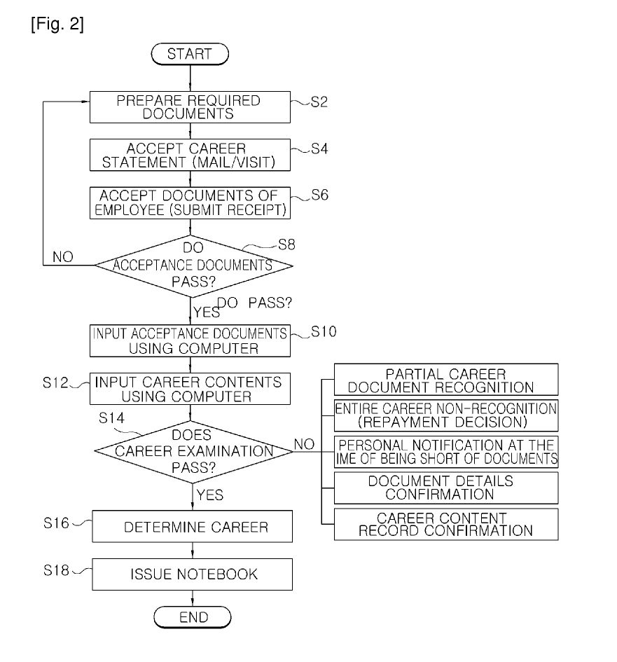

### BEST MODE FOR CARRYING OUT THE INVENTION

Hereinafter, a career authentication system and a career authentication method using the same according to the present invention will be described with reference to the accompanying drawings.

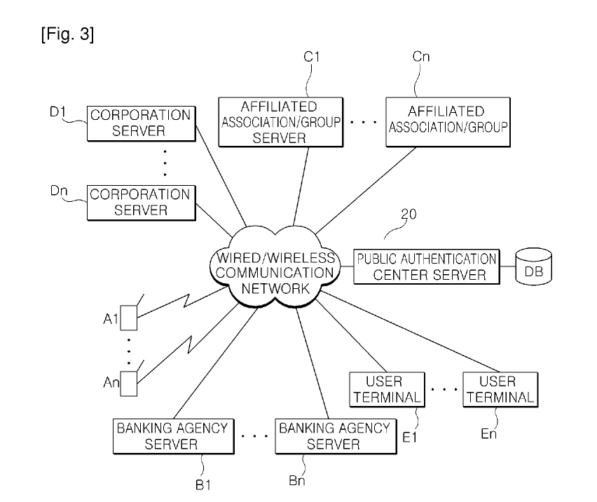

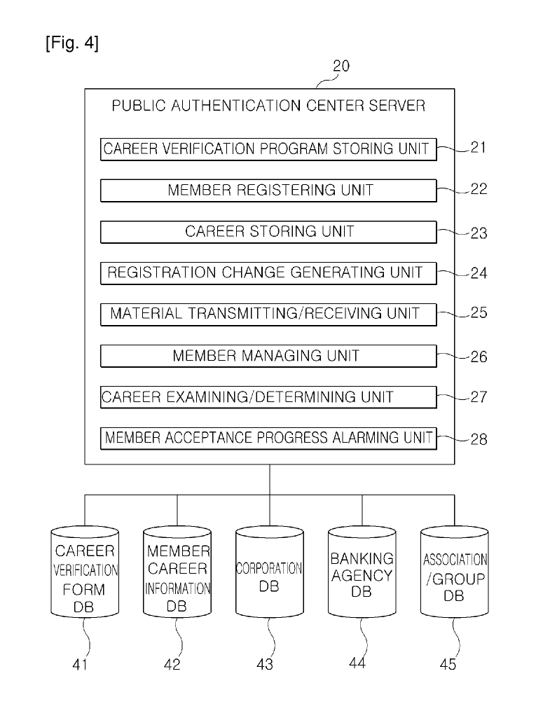

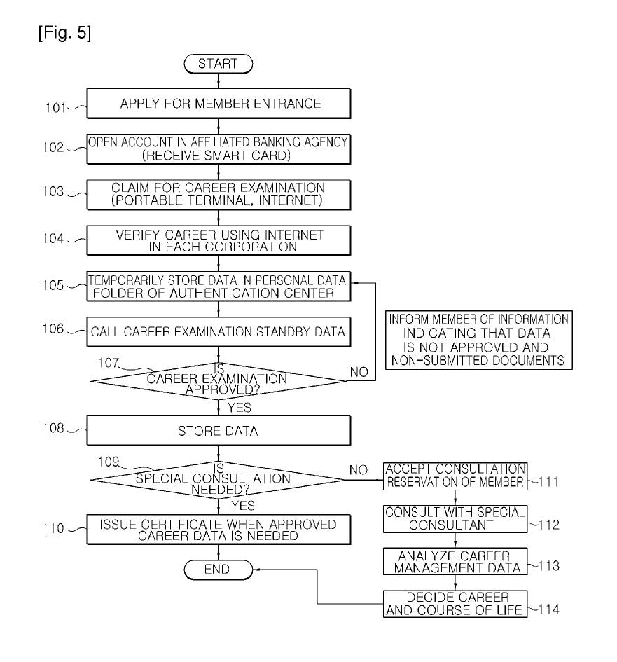

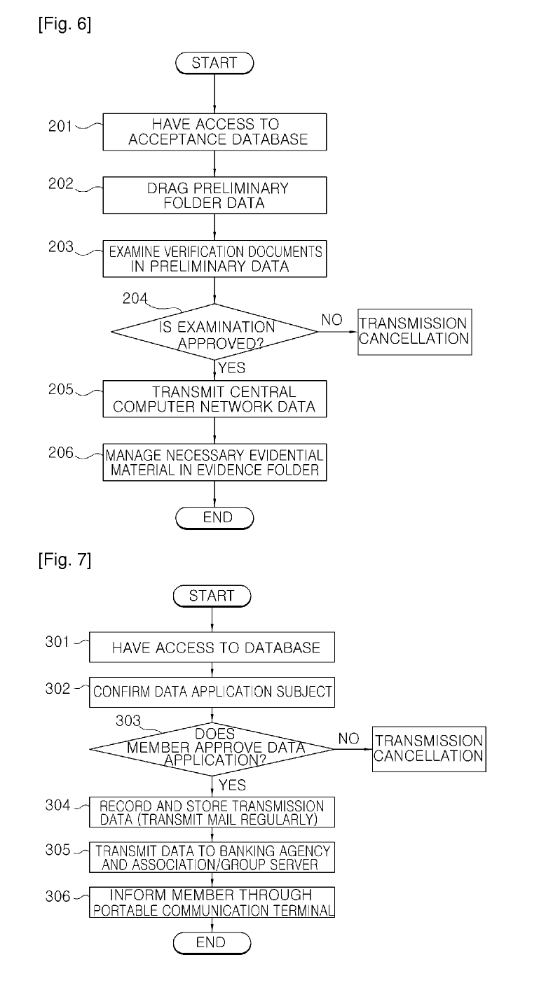

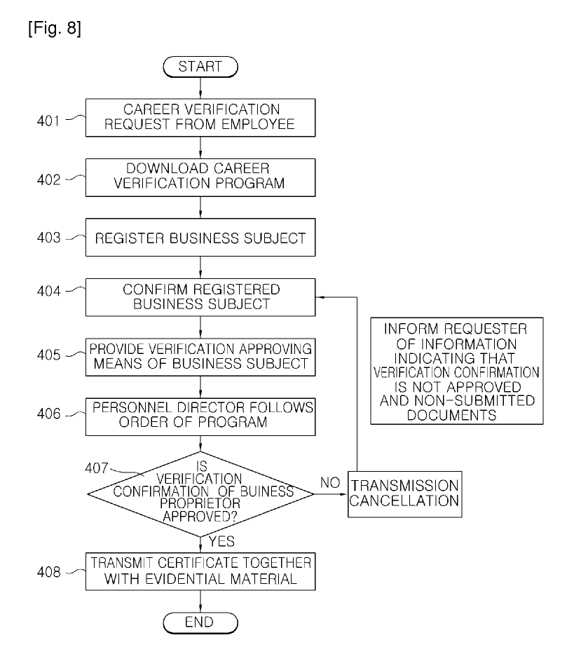

FIG. 3 is a diagram illustrating a schematic structure of a career authentication system according to the present invention. FIG. 4 is a block diagram schematically illustrating an inner structure of a public authentication center server shown in FIG. 3. FIG. 5 is a flowchart schematically illustrating a user career authentication process according to the present invention. FIG. 6 is a flowchart illustrating a user career examination and approval procedure according to the present invention. FIG. 7 is a flowchart illustrating a user career approval data transmission process according to the present invention. FIG. 8 is a flowchart illustrating a user career verification process according to the present invention.

As shown in FIGS. 3 to 8, a career authentication system according to the present invention includes one or more user terminals E1 to En that request to perform career authentication, one or more provider servers D1 to Dn that transmit an approved result according to a career authentication request of an experienced man, and a public authentication center server 20 that is connected to the user terminals E1 to En and the provider servers D1 to Dn through wired/wireless communication networks to allow data to be transmitted/received therebetween, receives career authentication request signals from the user terminals E1 to En and approved data from the provider servers D1 to Dn, determines whether career authentication is approved, and stores a determined result.

Reference numerals C1 to Cn denote one or more affiliated associations/group servers that request the public authentication center server 20 to transmit data of an experienced man to authenticate a career. When the data is requested, text messages are transmitted to the user terminals E1 to En and data is transmitted to the affiliated associations/group servers depending on an approval by a user. In this case, since the provider servers D1 to Dn may request to transmit data of the experienced man, the affiliated associations/group servers C1 to Cn may be regarded as the provider servers D1 to Dn.

The career authentication process starts when a user opens an account in banking facility servers B1 to Bn and transmits personalized information for career authentication to the public authentication center server 20, but the present invention is not limited thereto. The user may directly join the public authentication center server 20 and log into the public authentication center server.

As shown in FIG. 4, the public authentication center server 20 includes a career verification program storing unit 21, a member registering unit 22, a registration change generating unit 24, a career storing unit 23, a material transmitting/receiving unit 25, a career examining/determining unit 27, and a member acceptance progress alarming unit 28. The career verification program storing unit 21 stores a career verification program that includes corporation confirming means and personal career verifying means to perform a career verification process. The member registering unit 22 receives personal information input to become a member and registers the personal information in a member database. The registration change generating unit 24 changes data when registration change particulars are generated. The career storing unit 23 makes a predetermined capacity of directory using data that is received for a career statement, stores career verified data, and stores data approved through career examination in the database by job classification. The material transmitting/receiving unit 25 transmits the approved and stored career data to other associations or group servers, or a desired corporation. The career examining/determining unit 27 determines careers of members transmitted from the corporations, determines whether or not to approve the careers, and stores a determined result. The member acceptance progress alarming unit 28 transmits information indicating career authentication progress situation relating to the member to a terminal of the corresponding member, such that it is determined whether the careers are approved.

Although not shown in the drawings, the public authentication center server 20 may be mainly divided into a preliminary server and an approval server. In this case, the preliminary server stores career approval application acceptance dedicated data and the approval server stores the approved career.

Reference numerals 41 to 45 denote a career verification form database, a member career information database, a corporation database, a banking agency database, and an association/group database. The career verification form database 41 stores various career verification forms. The member career information database 42 stores career verified data for each of the members provided from the career storing unit 23. The corporation database 43 stores information for various corporations. The banking agency database 44 stores information of a plurality of banking agencies. The association/group database 45 stores information of a plurality of associations/groups. The data that is stored in the databases 41 to 45 may be updated on either a regular or occasional basis.

The career authentication system according to the present invention that has the above-described structure starts the operation when a person who desires to become a member is issued with a bankbook as his or her identity confirmation means in a cooperative banking agency online or offline (as described above, the present invention is not limited thereto). The cooperative banking agencies C1 to Cn simultaneously accept a member joining application and a bankbook opening application. If the cooperative banking agencies C1 to Cn transmit the accepted member joining application and documentary evidence to the public authentication center server 20, the public authentication center server 20 stores basic data of a member in the member career information database 42. If the member uses the user terminals E1 to En to request a personnel director of a corporation to transmit a personal career certificate, the personnel director downloads personal career verifying means (career verification program) and performs a career verifying process. The personnel director fills in a public authentication center verification form (not shown) according to the sequence of the career verification program, gets the signature from a representative of the corporation, and completes the career verification. Then, if the personnel director transmits the career certificate to the public authentication server 20, the career certificate is stored in the member career information database 42 as a personal file of a member of the public authentication server 20. The stored personal career information is sequentially received by a terminal (not shown, terminal connected to the public authentication center server through an internal local communication network) of a special examiner by job classification. The approval requested personal career is determined on the basis of an objective truth and evidential material. If each person is an employee associated with a special law, it is determined whether the career of the employee is appropriated to a special law becoming a reference of each field, and a personal career approval code that defines an official career recognition range is assigned to the employee.

The public authentication center server 20 further includes a member managing unit 26 that records and manages career information and personal information of members, which are input from an authentication agency terminal or a banking agency and registered in the server. The career examining/determining unit 27 checks career verification material for each of members and scanning material that are received in an approval standby state, and examines and determines a career.

The public authentication center server 20 includes a material transmitting/receiving unit 25 that recognizes data applicable to the necessary subject and transmits the data to a banking agency and an association/group that requires the necessary material, and can transmit/receive data. If the corporation transmits the career certificate of the member, the public authentication center server 20 temporarily stores the career certificate and inputs an approval code through the determination of the career examining/determining unit 27 in consideration of a career recognition range level of a special law. In this case, the data in an approval standby state is approved and a preferred reference of the data is changed on the basis of a unique number assigned to each member in order to prevent leakage of information through hacking, and the career is stored in the data as the unique number assigned to each member. The public authentication center server 20 recognizes a career recognition range under each special law and career change reason data, and transmits them to each member, if necessary.

The career authentication system according to the present invention performs a control operation such that each member uses a portable communication terminal to easily perform a career statement/confirmation process.

When each of the associations/group servers C1 to Cn requests to transmit authenticated career data, the career authentication system can confirm the corresponding association/group and recognize an object. Immediately after the data is requested, the career authentication system provides an alarm service to each member. The data is transmitted when the member consents. If an employee requests the public career authentication center 20 to consult with the public career authentication center 20 in regards to information needed to manage the career or making a decision, the public authentication center server 20 engages the employee. Then, the public authentication center server 20 prepares material needed for consultation on the basis of career data of the employee using career statement data as an analysis tool, and consults with the employee for his or her career.

Meanwhile, the public authentication center server 20 receives personal information that is input by a user terminal that requests to authenticate a career and allows the member registering unit to make and register a directory necessary for personal information and a career statement of a member in a database. The public authentication center server 20 stores the career authentication standby and the approved career (data in a career authentication standby state and publicized data may be separately stored). The public authentication center server 20 creates a verification document on a program through a confirmation of a representative of a corporation that verifies a career of a member, scans documentary evidence to verify verification contents, and stores it in the public authentication center server in a form of a personal file. The files that are stored in the public authentication center server 20 are examined by job classification in the acceptance order, and the approved careers are arranged. The files are converted into data and the data is stored in the public authentication center server 20.

In regards to non-approved career files, the public authentication center server 20 sends the mail including a guide document to the corresponding career verifier, such that the non-approved career files are corrected and complemented. After a predetermined period of time passes, the non-approved career files are automatically deleted. For each process, the process situation is informed to the portable communication terminals A1 to An of the employees that request to authenticate a career. When the affiliated association/group and businessman request to transmit the data stored in the public authentication center server 20, they can browse the data only when each member sends a consent message using a portable communication terminal. Upon the request from a member, a certificate is issued through a certificate issuing system using the Internet or a smart card (issued by a banking agency) in an affiliated banking agency. When consultation is needed for a career of a user through a reservation process at the request of each user, the public authentication center server 20 analyzes career particulars on the basis of the career data of the user, and provides consultation data that helps the consultant to complement a weak point and make a decision.

Referring to FIG. 5, the career authentication method using the career authentication system according to the present invention first starts from member entrance application (101) and confirming his or her identity at the time of joining an affiliated banking agency and receiving a smart card at the same time as application (102), and performs a career authentication application (103). Each corporation creates a career authentication file using a career verification authentication tool (career verification program) previously engaged with the public authentication center server 20 (104). Each corporation transmits the created career authentication file and a scanned evidential material (such as annuity summary, graduation certificate, issue certificate under the National Technical Qualifications Act, certificate of military registration, personnel record) necessary for various authentications to public authentication center server 20. Meanwhile, public authentication center server 20 temporarily stores the received career authentication file and the scanned information in a personal data folder for examination standby. Then, public authentication center server 20 calls the stored verification document of each corporation from the stored examination standby server file (106) and performs a career examination and approval process (107). That is, the career examiner compares data obtained by printing the examination standby server file (scanned file) with the called data (data of the career authentication file), assigns a verification code to each data according to the procedure required by various special laws, and checks an approval degree of each special law. If the career of the member is not related to the special law, the approval code is assigned on the basis of reliability of the objective truth. The files of the public authentication center server 20 are in an examination standby state on the basis of a resident registration number. If the data is approved, the approved data is stored in a form of an applicable file of a member unique number DB (108). Step 110 is a certificate issuing step in which, in a state where each approved data is stored on the basis of a member number and a resident registration number, a data subject (association/group or corporation) required in a wired/wireless communication network is recognized, only data that corresponds to the required data subject and is assigned with an approval code of a level under the special law or related laws is transmitted. Each corporation that employs engineers may also perform a function of searching technical material related to each special law or law with respect to all engineers of corporations based on a wired/wireless communication network technology with respect to the approved careers of the engineers. When the career examination approval is not given, data is not approved, and a message indicating that documents are insufficient is transmitted to the member.

Meanwhile, after the data storing step, it is determined whether special consultation is needed (109). When the special consultation is needed, a consultation reservation of the member is accepted (111) to consult with a special consultant (112). The career management data is analyzed (113), and the career and course of life are decided (114).

At the time of the career authentication of the engineer, the public authentication center server 20 automatically transmits the result to the corresponding engineer through the portable communication terminal, and the technical information of the engineer generated in the above process is stored in the database, and the career approving process and the material transmission data are stored and accumulated in a storage device during a predetermined period. However, the stored material transmission data is deleted through a predetermined procedure after a predetermined time. Accordingly, as compared with the career authentication method according to the related art, the career authentication method according to the present invention that authenticates the careers of all employees through the wired/wireless communication network is economical and simple, which results in decreasing authentication costs. Further, the authentication procedure is rationalized and the authentication time can be reduced.

The examination and approval procedure in the public authentication center server 20 will be described in detail with reference to FIG. 6. At the same time as the member entrance, in order to wait for a career examination, the career of the member is stored in the career storing unit 23 of the public authentication center server 20 for the purpose of a career examination (201). An examiner in a corresponding occupational field has access to the database using an examiner's terminal (not shown) (202). The corresponding examiner prints the evidential material while viewing the career verification data on the database, determines the career approval range of the evidential material and the statement material in consideration of the objectiveness and the order of the special laws of each occupational field, and examines and approves the career through the career examining/determining unit 27 (203 and 204). When the career is examined but not approved, the transmission is canceled. The approved data is classified into the files of the approved contents and the files of the approval standby contents on the basis of the member unique number instead of the existing resident residential number arranging method and stored in the member career database 42 of the public authentication center server 20. The public authentication center server 20 is connected to nations, related associations/groups, municipalities, and cooperative banking agencies that need data.

A procedure in this invention when a business subject in each industrial field verifies careers of the employees will be described in detail with reference to FIG. 8. First, when the employee requests to verify the career (401), a personnel director of each corporation downloads a career authentication program from the public authentication center server 20 (402). Then, through the corporation statement process (403), the category of business and a business range of each corporation are recorded in the public authentication center server 20. The confirmation process (404) of the public authentication center server 20 starts, and the verification approving means is provided to the computer of the corporation (including means that displays sealing of the corporation) (405). The corporation records the detailed career particulars of the employee and secures the evidential material, performs a recording process of the program according to the procedure of the given form, and scans the documentary evidence. In regards to the data, an official document confirming whether the signature of the corporation representative is displayed is included in the final scanning. Then, when the verification confirmation of the corporation representative is approved (407), the certificate and the evidential material are transmitted to the public authentication center server 20 (408). The data that is approved by the corporation representative is temporarily stored in a file that corresponds to the resident registration number in the public authentication center server 20. If the verification confirmation of the corporation representative is not approved, the transmission is cancelled, and information indicating non-submitted documents together with the verification confirmation non-approval message is transmitted to the requester.

The process in which the public authentication center server 20 according the present invention transmits the career approved data to the groups connected to the server will be described in detail with reference to FIG. 7. The related group inquires the public authentication center server 20 of the necessary career approval history of the engineer (301). The public authentication center server 20 discriminates the inquired groups and confirms the application subject (association/group) (302). Then, when the approval is given through the approval process (303) with respect to the inquiry request from the public authentication center server 20 to the member using the characters, a data transmitted date and the data inquiry subject are recorded in a counter (304), and the data is transmitted to the groups C1 to Cn that requests to transmit the data in a form applicable to the career approval subject (305). The information indicating whether the data is transmitted is transmitted to the portable communication terminal of the member through the characters (306). Further, the data transmission history for the predetermined time is informed to each member, and if the predetermined time elapses, the recorded material is regularly deleted.

In order to specifically describe the present invention, the following examples will be described. A description is given to the case where Mr. A majored in electrical engineering in a technical high school, worked for Korea Electric Power Corporation for 30 year, retired from Korea Electric Power Corporation, and is currently managing electrical fire in a building. First, Mr. A joins the public authentication center server 20 according to the present invention in order to apply for an electric engineer examination under the National Technical Qualifications Act. Mr. A joins the public authentication center server 20 with an identification card as identity confirmation means and a member joining application, and a career authentication center 20 confirms his identity and generates a member file of the public authentication center server 20. Mr. A calls up Korea Electric Power Corporation and a building managing corporation, downloads a career authentication program of the career authentication center, and requests to authenticate a career of Mr. A. The personnel directors that work for Korea Electric Power Corporation and the building managing corporation approve his career on the basis of personnel record contents of an employee. Specifically, when using the program, the personnel directors input a corporation name and a business registry number, and when the program is first downloaded, the personnel directors download a security program to confirm the corporation subject and input a password for approval. Then, a type of occupation of the employee and participated businesses in the corporation are recorded. The security program is executed with the approval from the personnel director who is invested with authority from a CEO, and the career management contents are stored in the member file through searching of the personal files of the public authentication center server. When the participated businesses are specifically recorded, the material capable of objectively proving the participated businesses is scanned, and is transmitted in a form of an image. The progress acceptance situation is informed from the public authentication center server 20 to the personal portable communication terminals A1 to An of Mr. A. The examiner of the public authentication center server 20 searches a program through which career history certificate and evidential materials are transmitted, and sequentially prints career content documents using a computer of each career examiner according to the career contents. When the career is approved through the examination, the approved/checked and printed documents are stored in a document storage box of the public authentication center server 20. However, the public authentication center server 20 stores the data on the basis of a resident registration number, but separately stores the data in a database of the public authentication center server 20 on the basis of a classification code of the examiner. The stored files in a form of a spread sheet are approved and stored. The examiner designates a range recognized through a criterion required by each special law according to the examination contents on the basis of member numbers that are classified according to types of industry and occupation. For example, a career of Mr. A who is an electrical engineer is recognized under National Technical Qualification Act but may not be recognized under Electric Technology Management Act and Electrical Construction Business Act. That is, a career recognition criterion is different between National Technical Qualification Act and Electric Technology Management Act and Electrical Construction Business Act. The career examiner determines a career recognition range required by each special law with respect to the same career, and the determined career contents are stored in the public authentication center server 20. As an example, the career of Mr. A at Korea Electric Power Corporation is 100% recognized as the career in the electricity field, and the career of Mr. A in the building managing business is a fire prevention career and thus the career of Mr. A in the building managing business is 80% recognized under Electric Technology Management Act. However, both the career of Mr. A at Korea Electric Power Corporation and the career of Mr. A in the building managing business are 100% recognized under National Technical Qualifications Act. Under Electrical Construction Business Act, the career in the maintenance work of the power facilities is 60% recognized, but the career in the electrical construction business is 100% recognized. The examiner of the public authentication center server 20 may classify the above criterions by business classification codes at the time of the examination and approval.

How to use the career approved contents will now be described. When Mr. A needs the career contents to take an examination of a certificate of qualification and the public authentication center server 20 can confirm the career, the public authentication center server 20 can be connected to Human Resources Development Service of Korea through the Internet, and thus transmit the approved contents in a form of a file thereto. The public authentication center server 20 browses career contents and whether the examination is possible is approved in real time. When the career is approved by a group under Electric Technology Management Act or a group under Electrical Construction Business Act through the public authentication center server 20, the groups browse the stored contents of the career authentication center server 20 and can approve them in real time. Each group can browse the personal career contents of Mr. A through the approval of Mr. A using the personal portable communication terminal.

In the above example, the corporation as the career verification subject will be specifically described. The businessman downloads the career verification program, inputs a name of the corporation, and receives an authentication program. The businessman records and verifies the career in a computer in the order of a type of occupation (management, account management/general management/production management/technical section), a type of section (account/management/law/general affairs/machine/electricity /construction/engineering works), tenure of office, and participated businesses, and transmits the documentary evidence to the public authentication center server 20 in a form of a file obtained by scanning.

In the public authentication center server 20, the authentication center examiner determines whether the documentary evidence is abnormal. Then, if the career is approved, the authentication center examiner can inform the member of the approved truth through the portable communication terminals A1 to An. In the groups or business enterprises that need authentication, for example, the groups under a special law can browse it as a career under the required special law because the special law is discriminated in the reception confirmation unit. If it is required to recognize the career as only the past objective career that is required in the business enterprise, all career recognition ranges can be adjusted.

In addition to the engineer, the case of Mr. B who works for a corporation in another type of occupation will be described. Mr. B majored in the subject of business management and graduated from XX University, and worked for XX construction as a treasurer for 15 years. Mr. B was interested in career management and development of his ability, and joined the public authentication center server 20 as a member. If performing the identity confirmation process through an identification card capable of confirming his identity and the filled member entrance application, a file of Mr. B is generated in the public authentication center server 20. If Mr. B requests his corporation to authenticate a career, a personnel director requires career authentication through the public authentication center server 20 in the above-described process. Mr. B who has worked for 15 years desires to develop his ability, recognizes that a specific subject needs to be studied during a long period, and requests the public authentication center server 20 for consultation. After the consultation acceptance, Mr. B consults with a consultation center consultant at an engaged time. Specifically, the consultant consults with the member about Mr. B s major and minor and a member s goal on the basis of an account field career and a language capability level, designs a curriculum and course lectures to attend, which are useful for a career such that the member can achieve his goal, and provides them to the member. As a result, Mr. B as an expert in an account field studies thoroughly the cultural subjects whose knowledge is poor and takes the necessary language course, thereby improving labor productivity. Mr. B can accumulate an elementary knowledge that will help career management and can show his ability in his corporation.

The member joining through the collective agreement will be exemplified. The business enterprises desired to collectively join the public authentication center server 20 having strength in two objectives. An XX corporation concluded a collective agreement with the public authentication center server 20 in order to effectively manage a human resource development program and careers of all employees, and jointly developed a program through which a program of general affairs and personal fields needed in a corporation can be shared with the public authentication center server 20. The developed program is linked to the member s human resource management program and the public authentication center server 20 and human resource material of the member corporation are automatically recorded. The participated businesses of an individual person can be specifically managed. In this program, the careers of the employees of the member corporation are automatically recorded, and necessary education particulars are automatically checked whenever the predetermined time passes, and the education contents that are needed to achieve personal goals can be individually managed in the personal requirements. At the time of internal movement, the career authentication contents are recorded, and a career examiner of the public authentication center server 20 regularly records and stores the career contents. An example of the internal movement will now be described. When the internal movement is made in the same type of section, there is no problem. However, for example, Mr. C worked as the head of the general affairs section for 3 years by the end of 2006 and was subjected to the internal movement as the head of an electricity technology education team related to electricity that was a special subject of study. In this case, the examiner of the public authentication center server 20 differently records career contents for a type of occupation and a type of section at the time of approving careers. For example, the examiner inputs a code indicating that Mr. C worked in the general affairs section (as the above example, number 2 code in a type of occupation) for three years and another code indicating that Mr. C worked in the electricity field (number 2 code in a type of section) in the technical work (as the above example, number 5 code in a type of occupation). Therefore, since the career contents are differently input, career contents are not simply recorded, and the specific and proper codes are input to specifically record the career contents.

Additionally, in the career authentication system according to the present invention, when a user uses a server or a communication medium to have access to the server and requires to provide various authentication documents or settle service charges, data is transmitted and received and the service charges can be automatically paid from a bankbook opened in a corresponding banking agency. The joined member uses the Internet or a communication apparatus to know a career authentication claim progress situation or view the career certificate, and may obtain the career related data according to the necessary criterion. When the related association/group or corporation requests the necessary career according to the special law needed in the banking agency or the Internet and requests the authenticated career particulars, it is possible to recognize the career confirmation form and the procedure under the required special law.

Further, the career authentication system according to the present invention includes a career analyzing unit that analyzes material of career management consultation applicant such that the applicant engages a consultation reservation time with the public career manager and consults with the public career manager to systematically manage a career.

1. A career authentication system comprising:
a career storing unit that receives a career verification data from a corporation server which performs career verification for a member and outputs career verification data, stores the career verification data in a storing unit, and stores an approved career information in the storing unit;
a career examining/determining unit that examines the stored career verification data, determines whether or not to approve the career, creates the approved career information when the career is approved, and transmits the approved career information to the career storing unit; and
a material transmitting/receiving unit that retrieve and outputs the approved career information of the member which is stored in the storing unit when requesting for the approved career information of the corresponding member is received from outside.

2. The career authentication system of claim 1,
wherein the career examining/determining unit determines a career recognition range for the career verification data according to a career recognition criterion.

3. The career authentication system of claim 1, further comprising:
a member acceptance progress alarming unit that transmits information indicating career authentication progress situation relating to the member to a terminal of the corresponding member.

4. The career authentication system of claim 3,
wherein the member acceptance progress alarming unit transmits a message indicating that the career is not approved to the terminal of the corresponding member.

5. The career authentication system of claim 3,
wherein the member acceptance progress alarming unit transmits a message indicating that the approved career information relating to the corresponding member is requested from the outside to the terminal of the corresponding member.

6. The career authentication system of claim 3,
wherein the member acceptance progress alarming unit transmits a message indicating that browsing of the approved career information relating to the corresponding member is requested from the outside to the terminal of the corresponding member.

7. A career authentication method comprising:
a first step of allowing a career storing unit to receive a career verification data from a corporation server which performs career verification for a member and outputs career verification data and allowing a storing unit to store the career verification data;
a second step of allowing a career examining/determining unit to examine the stored career verification data, to determine whether or not to approve the career, and to create the approved career information when the career is approved;
a third step of allowing the career storing unit to stores an approved career information in the storing unit; and
a fourth step of allowing a material transmitting/receiving unit to retrieve and outputs the approved career information of the member which is stored in the storing unit when requesting for the approved career information of the corresponding member is received from outside.

8. The career authentication method of claim 7,
wherein the second step further comprises determining a career recognition range for the career verification data according to a career recognition criterion.

9. The career authentication method of claim 7, further comprising:
a fifth step of allowing a member acceptance progress alarming unit to transmit information indicating career authentication progress situation relating to the member to a terminal of the corresponding member.

10. The career authentication method of claim 9,
wherein the fifth step comprises allowing the member acceptance progress alarming unit to transmit a message indicating that the career is not approved to the terminal of the corresponding member.

11. The career authentication method of claim 9,
wherein the fifth step comprises allowing the member acceptance progress alarming unit to transmit a message indicating that the approved career information relating to the corresponding member is requested from the outside to the terminal of the corresponding member.

12. The career authentication method of claim 9,
wherein the fifth step comprises allowing the member acceptance progress alarming unit to transmit a message indicating that browsing of the approved career information relating to the corresponding member is requested from the outside to the terminal of the corresponding member.

13. The career authentication method of claim 7,
wherein the first step comprises temporarily storing the career verification data on the basis of a resident registration number of the corresponding member.

14. The career authentication method of claim 7,
wherein the third step comprises storing the approved career information on the basis of a member number of the corresponding member.

15. A computer readable recording medium having a program that is stored therein to execute the method of claim 7.
